(19) United States
(12) Patent Application Publication
(10) Pub. No.: US 2009/0049240 A1
(43) Pub. Date: Feb. 19, 2009

(54) APPARATUS AND METHOD FOR STORAGE MANAGEMENT SYSTEM

(75) Inventors: Kazuichi Oe, Kawasaki (JP); Tatsuo Kumano, Kawasaki (JP); Yasuo Noguchi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kanagawa (JP)

(21) Appl. No.: 12/190,898

(22) Filed: Aug. 13, 2008

(30) Foreign Application Priority Data
Aug. 17, 2007 (JP) 2007-212798

(51) Int. Cl. G06F 12/16; G06F 12/02

(52) U.S. Cl. 711/114; 711/E12.103; 711/E12.002

(57) ABSTRACT

A storage apparatus, method and program are provided. The apparatus includes a management information storing unit that stores management information which defines storage nodes to allocate primary data used as a destination of access and secondary data used as a backup. The apparatus also includes data allocation unit that divides storage nodes 5 into groups, and assigns data allocation destination so that the data allocation destination of the primary data and the data allocation destination of the secondary data with the same content as the primary data are not in the same group. The apparatus also includes an operation mode switching unit that replaces the role of primary data assigned to the storage node which belongs to the group subject to suspension with that of the secondary data that corresponds to the primary data.

### CROSS-REFERENCE TO RELATED APPLICATIONS

This application is related to and claims priority to application having serial number 2007-212798 filed Aug. 17, 2007 and incorporated by reference herein.

### BACKGROUND

1. Field

The embodiments discussed herein are directed to a storage management system.

2. Description of the Related Art

Data processing using computers has been widely performed, thus storage technology for accumulating and using data have become increasingly important. As storage technology to realize faster data access and higher reliability, Redundant Arrays of Independent Disks (RAID) has been widely used. RAID distributes and allocates data to a plurality of disk apparatuses by splitting and replicating data as required. This may allow faster processing by distributing loads among a plurality of disks and higher reliability by storing data redundantly.

To realize faster processing and higher reliability, distributed storage systems which apply RAID theory have been built. Such distributed storage system provides a plurality of storage nodes and a network to connect the storage nodes. Each of the storage nodes internally manages a disk apparatus and a network communication function. Faster processing and higher reliability are realized for an entire system by distributing and allocating data to a plurality of storage nodes.

Assuming that when redundancy is applied to data in a distributed storage system, which unit data having the same content are allocated to a plurality of storage nodes. At this time, for a write request, all data having the same content needs to be updated in order to maintain consistency of data. On the other hand, for a read request, control methods include a control method to dynamically determine the node from where the data is read based on loads to storage nodes and a control method to define roles of operation data and backup data beforehand, and the operation data is read in normal operation.

Generally, the second control method is employed, because the second control method may be simpler and achieves faster data access.

The distributed storage system needs to supply power to many storage nodes, but has a drawback that increases power consumption. Conventionally, redundancy is applied to data, i.e., providing operation data and backup data. That is to divide a plurality of storage nodes into an active system for retaining only operation data and a standby system for retaining only backup data. Conventionally, a system may be operated only with an active system while power supply to a standby system is suspended at normal operation and only when a write operation is reflected to the backup data, power is supplied to the standby system. Another conventional method that instead of completely suspend power supply, power is supplied to a standby system for a predetermined period before reading operation data completes in case of the read operation failure.

### SUMMARY

It is an aspect of an embodiments discussed herein to provide causes a computer to function as the following measures, a management information storing unit that designates primary data which may be used as destination of access at access request and secondary data which may be used as a backup from a plurality of data, and stores management information which defines storage nodes to allocate the primary data and the secondary data; a data allocation unit that divides the plurality of storage nodes into at least two groups, manipulates the management information stored in the management information storing unit, and assigns data allocation destination so that the data allocation destination of the primary data and the data allocation destination of the secondary data with the same content as the primary data are not in the same group; and an operation mode switching unit that manipulates the management information stored in the management information storing unit and replaces roles of the primary data assigned to a storage node belongs to the group subject to suspension and the secondary data which has the same content as the primary data, upon receiving a command to switch to a power saving mode in which one of groups defined in the data allocation unit is suspended.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates an overview of an embodiment;

FIG. 2 illustrates a system configuration of a distributed storage system;

FIG. 3 illustrates a hardware configuration of a storage node;

FIG. 4 illustrates a hardware configuration of a control node;

FIG. 5 illustrates an example of a first data structure of a logical volume;

FIG. 6 illustrates functions of each of nodes comprising a distributed storage system;

FIG. 7 illustrates a data structure of a slice information table;

FIG. 8 illustrates a data structure of a logical volume table;

FIG. 9 illustrates an example of structure of a ring buffer where redundant data is stored;

FIG. 10 illustrates processing of transition to power saving mode;

FIG. 11 illustrates an example of transition flow to power saving mode;

FIG. 12 illustrates a second data structure of a logical volume;

FIG. 13 illustrates an example of a flow of writing data during power saving mode;

FIG. 14 illustrates a processing of a write back operation of redundant data;

FIG. 15 illustrates a flow of a write back operation of redundant data;

FIG. 16 illustrates a processing to return from a power saving mode; and

FIG. 17 illustrates an example of flow returning from a power saving mode.

### DETAILED DESCRIPTION OF THE EMBODIMENTS

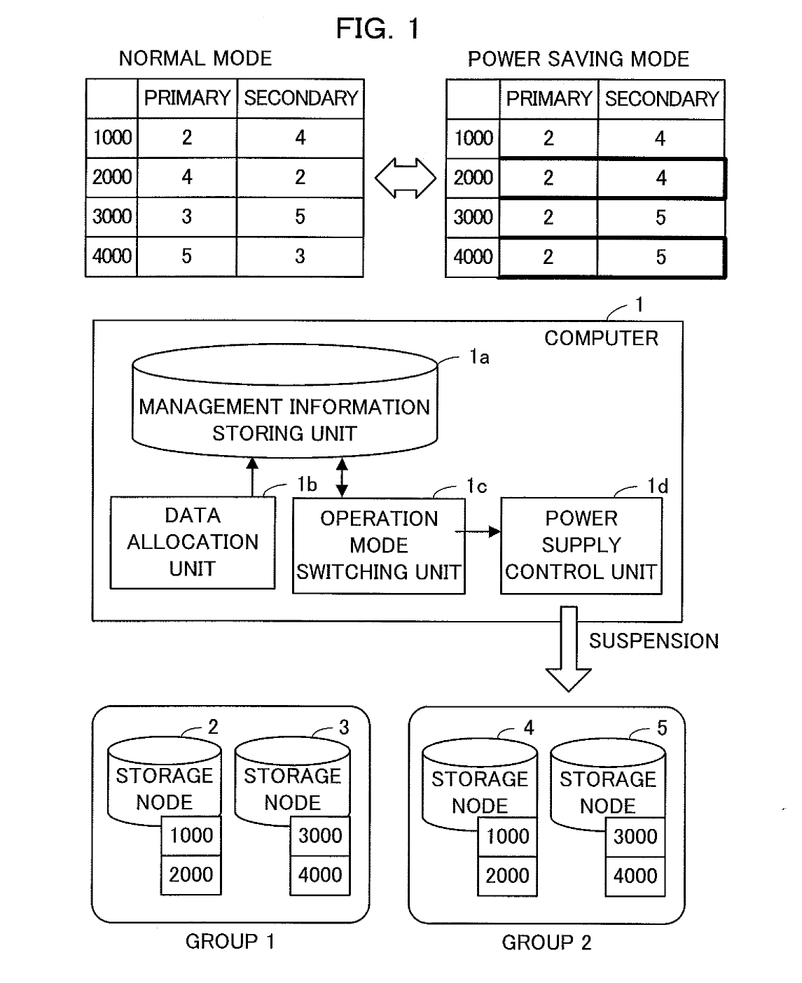

FIG. 1 illustrates an embodiment of a distributed storage system in which a plurality of data having the same content are distributed to storage nodes 2, 3, 4, and 5 and managed. This distributed storage system has a computer 1 and storage nodes 2, 3, 4, and 5.

The computer 1 is a computer to manage status of data allocation to the storage nodes 2, 3, 4, and 5. The computer 1 has a management information storing unit 1a, a data allocation unit 1b, an operation mode switching unit 1c and a power supply control unit 1d. These units may cause the computer 1 to execute a storage management program in an embodiment.

The management information storing unit 1a stores management information that manages status of data allocation. In the management information, storage nodes to allocate primary data and secondary data are designated from a plurality of data having the same content. The primary data may be used as a destination of access when an access request is generated for the data while the secondary data may be used as a backup.

The data allocation unit 1b divides the storage nodes 2, 3, 4, and 5 into at least two groups when allocating data to the storage nodes. The data allocation unit 1b assigns the allocation destination of each data so that the allocation destination of primary data and secondary data are not in the same group. The data allocation unit 1b updates the management information stored in the management information storing unit 1a based on the allocation result. Thereafter, writing and reading data is performed based on the management information stored in the management information storing unit 1a.

Upon the operation mode switching unit 1c receiving a command to switch to a power saving mode, and prepares for switching to the mode by manipulating management information stored in the management information storing unit 1a. The power saving mode is an operation mode in which the storage nodes 2, 3, 4, and 5 are partially suspended.

The operation mode switching unit 1c identifies a group subject to suspension among groups defined by the data allocation unit 1b. The operation mode switching unit 1c changes the role of primary data assigned to a storage node subject to suspension to that of secondary data by manipulating data stored in the management information storing unit 1a. At the same time, the operation mode switching unit 1c changes the role of secondary data (i.e., the data assigned to a storage node belongs to a group other than the group subject to suspension) corresponding to above primary data before the change to the role of the primary data.

The power supply control unit 1d notifies power-off to the storage node which belongs to the group subject to suspension, i.e., to which only secondary data is allocated by the process at the operation mode switching unit 1c. Then, the notified storage node is suspended and the distributed storage system is switched to the power saving mode. At this time, all primary data are allocated to the storage nodes 2, 3, 4, and 5 under operation. Therefore, the data access is not interrupted.

There may be various methods to issue a command to switch into a power saving mode.

For example, an administrator of a distributed storage system may manually issue a switching command by operating a computer 1 or the administrator's terminal.

Another method is in which an administrator presets a time to issue a switching command at the computer 1 or the administrator's terminal so that the command is automatically issued when the preset time is reached. Another is in which a monitoring unit is provided for continuously monitoring loads to the storage nodes 2, 3, 4, and 5, and when the load is lower than the predefined threshold value, a switching command is automatically issued.

There may be various methods to select a group subject to suspension when switching into power saving mode. For example, an administrator may explicitly select a group subject to suspension in each time. There may be a method to select a group subject to suspension randomly from a plurality of groups. Another method may be considered in which a group subject to suspension is predetermined and fixed. Yet another method is considered in which a group is sequentially selected which is different from previous selection by applying a round-robin method. The round-robin method may prevent uneven operation hours of storage nodes among groups, and prevents performance deterioration of a specific storage node progressing faster than the other storage nodes.

In FIG. 1, redundancy is applied to data 1000, 2000, 3000, and 4000 as primary and secondary data, and distributed and allocated to the storage nodes 2, 3, 4, and 5. The data allocation unit 1b allocates data as follows respectively:

(a) Primary data of data 1000 to the storage node 2, secondary data of data 1000 to the storage node 4;

(b) Primary data of data 2000 to the storage node 4, and secondary data of data 2000 to the storage node 2;

(c) Primary data of data 3000 to storage node 3) and secondary data of data 3000 to the storage node 5;

(d) Primary data of data 4000 to the storage node 5 and secondary data of data 4000 to storage node 3 respectively.

The data allocation unit 1b divides the storage nodes 2, 3, 4, and 5 into two groups: group 1 and group 2. The storage nodes 2 and 3 comprise the group 1 while the storage nodes 4 and 5 comprise the group 2.

Upon a command to switch into power saving mode is issued with the group 2 subject to suspension, the operation mode switching unit 1c manipulates the management information stored in the management information storing unit 1a and the allocation status of data 2000 and 4000 are changed. That is the secondary data of data 2000 allocated to the storage node 2 is changed into the primary data while the primary data of data 2000 allocated to the storage node 4 is changed into the secondary data. The secondary data of data 4000 allocated to the storage node 3 is changed into the primary data, and the primary data of data 4000 allocated to the storage node 5 is changed into the secondary data as well.

As a result, the data is allocated as follows: the primary data of the data 1000 and data 2000 are allocated to the storage node 2, the primary data of data 3000 and data 4000 are allocated to the storage node 3, the secondary data of data 1000 and data 2000 are allocated to the storage node 4, and the secondary data of data 3000 and data 4000 are allocated to the storage node 5 respectively. Thus, no access request is generated for the storage nodes 4 and 5 which belong to the group 2. The power supply control unit 1d suspends the storage nodes 4 and 5, thereby the distributed storage system turns into the power saving mode.

In above explanation, the computer 1 has explained as different device from the storage nodes 2 to 5, however either one of the storage nodes 2 to 5 can provide functions of the computer 1.

According to such computer 1, data allocation unit 1b divides storage node 2 to 5 into at least two groups. Then data are allocated so that primary data and secondly data (which is pair of the primary data) are not in the same group. Upon a command to switch into power saving mode is issued in which one of the group is suspended, the operation mode switching unit 1c replaces the role of primary data assigned to the storage node which belongs to the group subject to suspension with that of the secondary data having the same content as the primary data. As a result, the storage node which belongs to the group subject to suspension does not have any data allocated.

As a result, only storage node which belongs to one group is accessed at data access, and the power supply control unit 1d enables to stop a storage node which belong to the group not used as an access destination. Thus power saving is achieved by distributing loads to all the storage nodes 2 to 5 when the load is high, while partially suspending the storage nodes when the load is low.

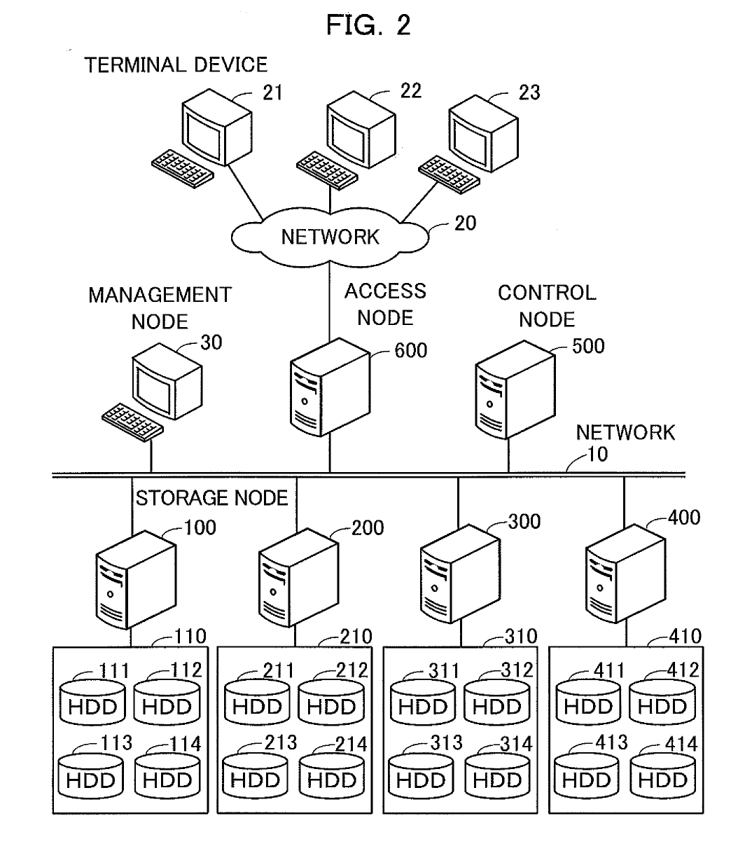

FIG. 2 illustrates a system configuration of a distributed storage system of an embodiment. The distributed storage system illustrated in FIG. 2 improves reliability and performance by distributing data having the same content to a plurality of storage nodes connected by a network.

In the distributed storage system according to an embodiment, storage nodes 100, 200, 300, and 400 and a control node 500, an access node 600 and a management node 300 are interconnected via a network 10. Terminals 21, 22, and 23 are connected to the access node 600 via a network 20.

A storage device 110 may be connected to the storage node 100, a storage device 210 may be connected to the storage node 200, a storage device 310 may be connected to the storage node 300, and a storage device 410 may be connected to the storage node 400. The storage nodes 100, 200, 300 and 400 manage data stored in the connected storage devices 110, 210, 310, and 410 respectively and provide the managing data to the access node 600 via the network 10 respectively. The storage nodes 100,200, 300 and 400 manage data by applying redundancy to the data. Thus, data with the same content may be managed at least by two storage nodes.

Hard disk drives (HDDs) 111,112, 113, and 114 are mounted to the storage device 110. Hard disk drives (HDDS) 211,212, 213, and 214 are mounted to the storage device 210. Hard disk drives (HDDs) 311,312, 313, and 314 are mounted to the storage device 310. Hard disk drives (HDDs) 411,412, 413, and 414 are mounted to the storage device 410. The storage devices 110, 210, 310, and 410 are RAID systems using a plurality of built-in HDDs. In an example embodiment, the storage devices 110, 210, 310, and 410 provide a disk management service of RAID 5.

The control node 500 manages the storage nodes 100, 200, 300, and 400. The control node 500 retains a logical volume indicating statuses of data allocation. The control node 500 acquires information on data management from the storage nodes 100, 200, 300, and 400 and updates the logical volume as required. The control node 500 notifies the content of the update to those storage nodes influenced by the update. The logical volume will be described in detail later.

The access node 600 provides information processing service to terminal devices 21, 22, and 23 using data managed by the storage nodes 100, 200, 300 and 400. Thus, the access node 600 executes a predetermined program in response to a request from the terminal devices 21, 22, and 23 and the accesses storage nodes 100, 200, 300, and 400 as required. The access node 600 acquires a logical volume from the control node 500 and identifies the storage node to be accessed based on the acquired logical volume.

A management node 30 is a terminal device which an administrator of the distributed storage system operates. The administrator can set various settings required for operation by operating the management node 30 and accessing the storage nodes 100, 200, 300, and 400, the control node 500, and the access node 600.

Now, a hardware configuration of the storage nodes 100, 200, 300, and 400, the control node 500, and the access node 600, the terminal devices 21, 22, and 23, and the management node 30 will be explained.

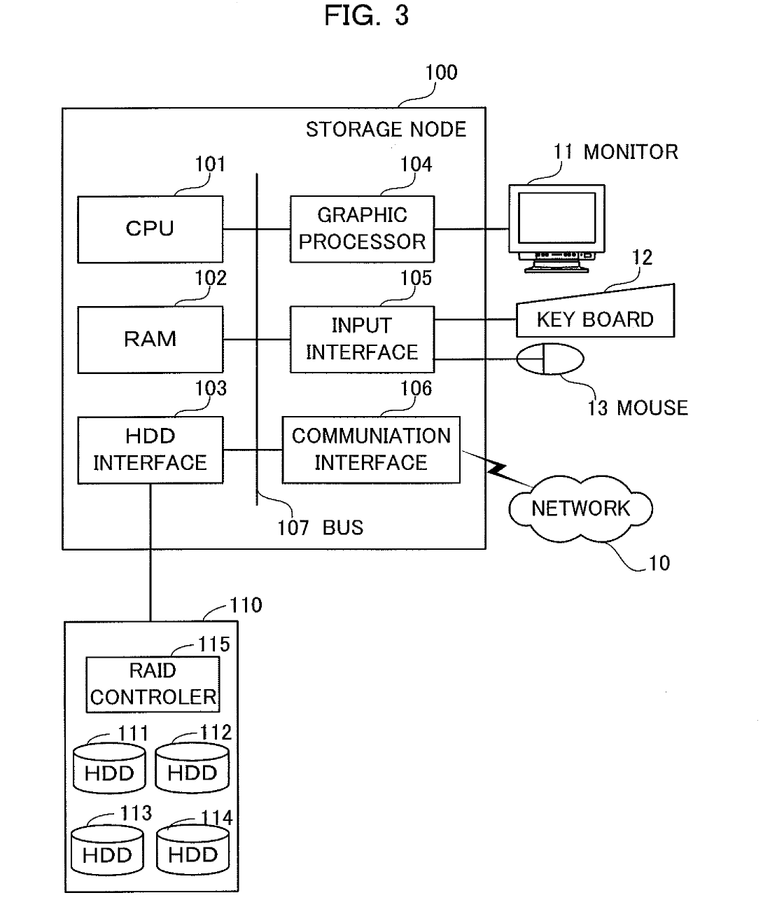

FIG. 3 illustrates a hardware configuration of a storage node. An entire storage node 10 may be controlled by a central processing unit (CPU) 101. The CPU 101 may be connected to a random access memory (RAM) 102, a hard disk drive (HDD) interface 103, a graphic processor 104, an input interface 105, and a communication interface 106 via a bus 107.

The RAM 102 temporarily stores at least a part of the operating system programs or application programs executed by the CPU 101. The RAM 102 also stores various data required for processing by the CPU 101.

The HDD interface 103 may be connected to the storage device 110. The HDD interface 103 communicates with a built-in RAID controller 115 within the storage device 110 and inputs and outputs data to and from the storage device 110. The RAID controller 115 within the storage device 110 has functions of RAID 0 to 5, and manages HDD 111 to 114 as one hard disk drive.

The graphic processor 104 may be connected to a monitor 11. The graphic processor 104 displays images on the screen of the monitor 11 according to a command from the CPU 101. The input interface 105 may be connected to a keyboard 12 and a mouse 13. The input interface 105 transmits signals received from the keyboard 12 or the mouse 13 to the CPU 101 via the bus 107.

The communication interface 106 may be connected to the network 10. The communication interface 106 sends and receiving data to and from other computers via the network 10.

Note that the storage nodes 200, 300, and 400 can be represented by the same hardware configuration as that of the storage node 100.

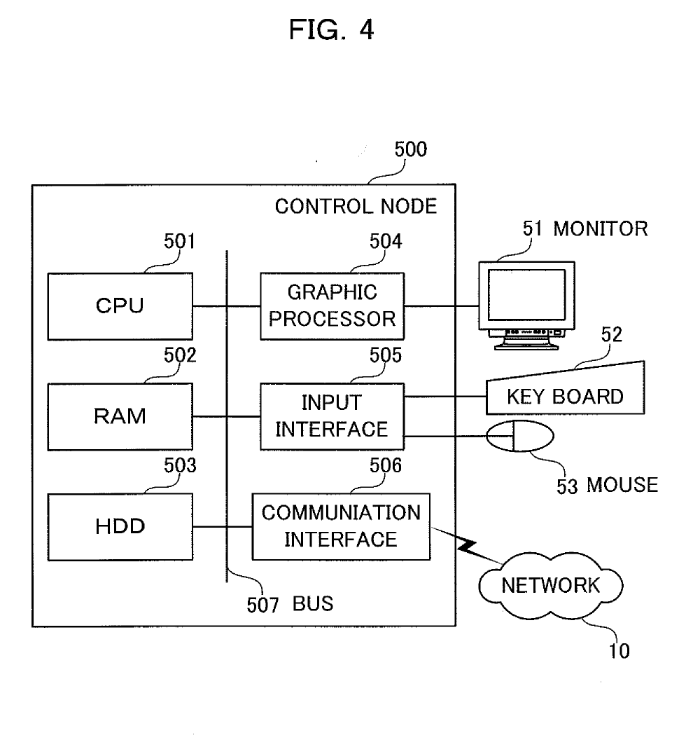

FIG. 4 illustrates a hardware configuration of a control node. An entire control node 500 may be controlled by a central processing unit (CPU) 501. The CPU 501 may be connected to a random access memory (RAM) 502, a hard disk drive (HDD) 503, a graphic processor 504, an input interface 505, and a communication interface 506 via a bus 507.

The RAM 502 temporarily stores at least a part of programs of the operating systems or application programs executed by the CPU 501. The RAM 502 also stores various data required for processing by the CPU 501. The HDD 503 stores the operating system programs.

The graphic processor 504 may be connected to a monitor 51. The graphic processor 504 displays images on the screen of the monitor 51 according to a command from the CPU 501. The input interface 505 may be connected to a keyboard 52 and a mouse 53. The input interface 505 transmits signals received from the keyboard 52 or the mouse 53 to the CPU 501 via the bus 507. The communication interface 506 may be connected to the network 10. The communication interface 506 sends and receiving data to and from other computers via the network 10.

Note that the access node 600, the terminal devices 21, 22, and 23 and the management node 30 can be represented by the same hardware configuration as that of the control node 500. However, the access node 600 further provides an interface to connect to the network 20 in addition to a communication interface to connect to the network 10.

The processing functions of an example embodiment may be realized by above hardware configuration.

Now a logical volume provided by the control node 500 to the access node 600 will be explained. The logical volume is a virtual volume that may allow the access node 600 to easily use data distributed and managed by the storage nodes 100, 200, 300 and 400.

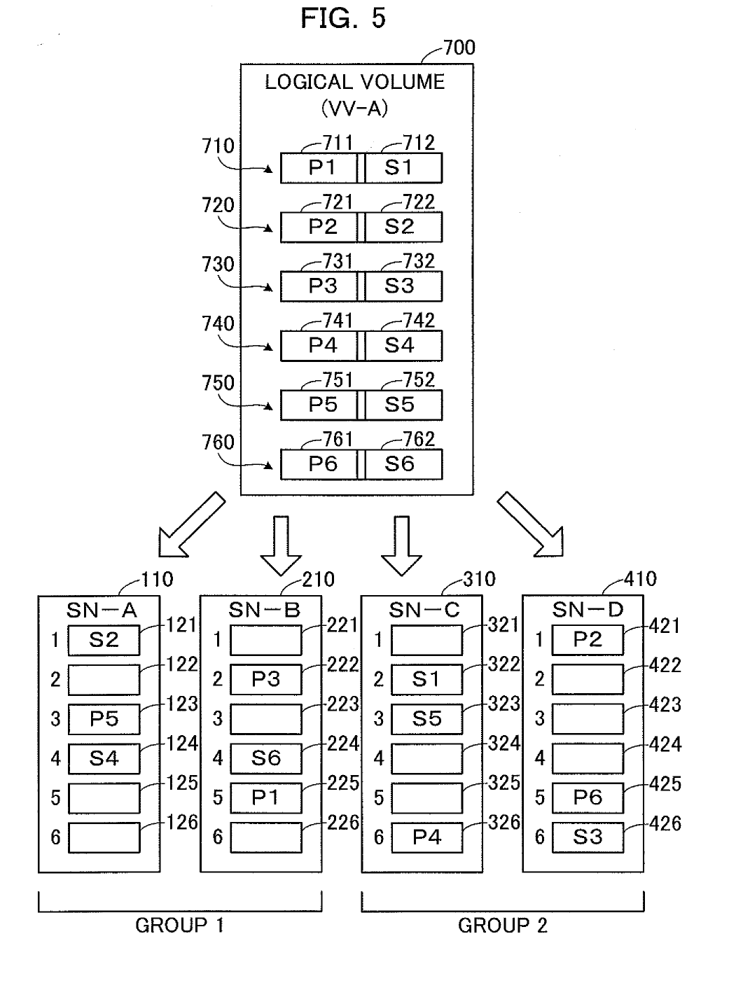

FIG. 5 illustrates an example of a first data structure of the logical volume. A logical volume ID, “VV-A” is assigned to a logical volume 700. A node ID “SN-A” is assigned to the storage node 100, a node ID “SN-B” is assigned to the storage node 200, a node ID “SN-C” is assigned to the storage node 300, and a node ID “SN-D” is assigned to the storage node 400 respectively.

Moreover, a group ID, “group 1” is assigned to the storage nodes 100 and 200. Thus, that the storage nodes 100 and 200 comprise one group. A group ID, “group 2” is assigned to the storage nodes 300 and 400. Thus, that storage nodes 300 and 400 comprise a group different from that of storage nodes 100 and 200.

A logical disk of RAID 5 are configured for each of the storage devices 110, 210, 310, and 410 connected to the storage nodes 100, 200, 300, and 400. The logical disk may be divided into six slices and managed collectively within each storage node.

An example of FIG. 5 illustrates;

(1)A storage area within the storage device 110 may be divided into six slices 121 to 126;

(2)A storage area within the storage device 210 may be divided into six slices 221 to 226;

(3)A storage area within the storage device 310 may be divided into six slices 321 to 326; and

(4)A storage area within the storage device 410 may be divided into six slices 421 to 426

The logical volume 700 includes units of segments 710, 720, 730, 740, 750, and 760. Each of the segments 710, 720, 730, 740, 750, and 760 includes of a pair of primary slice and secondary slice respectively. In this case, a primary slices are 711, 721, 731, 741, 751, and 761, while secondary slices are 712, 722, 732, 742, 752, and 762. The slice belong to the same segment is allocated so that it belongs to a storage node with different group ID.

In FIG. 5, a slice ID is indicated by a combination of alphabet “P” or “S” and a numeric character. The “P” indicates it is a primary slice, while “S” indicates it is the secondary slice. The numeric character subsequent to the alphabet indicates the order of segments. For instance, the primary slice 711 of the first segment 710 is represented by “P1”, and the secondary slice indicated by “S1”.

Each of primary and secondary slices of the logical volume 700 with this structure corresponds to one of slices in the storage devices 110, 210, 310, and 410. For example, the primary slice of the segment 710 corresponds to the slice 225 in the storage device 210, and the secondary slice 712 corresponds to the slice 322 in the storage device 310.

The storage devices 110, 210, 310, and 410 store data of a primary slice or a secondary slice correspond to a slice in each of the storage device. Note that a plurality of logical volumes can be created depending on, for example, usage of data or authority of an access source. The access node 600 can not recognize a slice which is not represented by a logical volume. Therefore, using a plurality of logical volumes depending on situation can contribute to improve security.

Next, a configuration of modules of the storage nodes 100, 200, 300, and 400, the control node 500, and the access node 600 will be explained.

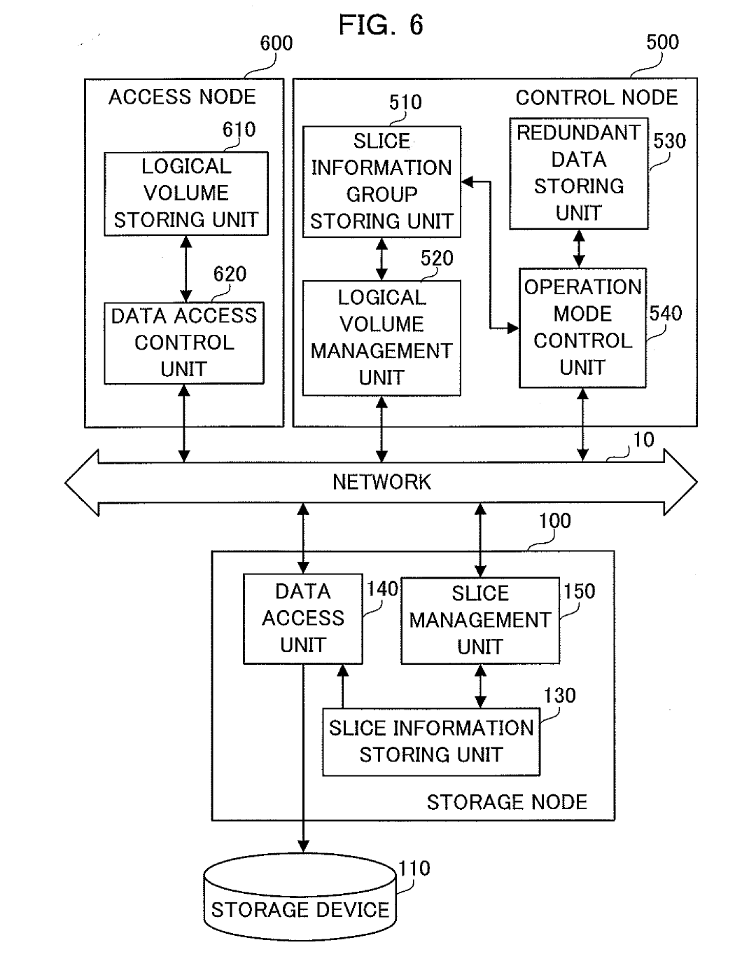

FIG. 6 is a block diagram illustrating functions of each of nodes comprising a distributed storage system. FIG. 6 shows a module configuration of the storage node 100. The storage nodes 200, 300, and 400 may be realized by the same configuration as that of the storage node 100.

The storage node 100 has a slice information storing unit 130, a data access unit 140, and a slice management unit 150.

The slice information storing unit 130 stores information on slices stored in the storage device 110. The information on slices includes an address for identifying a slice, and type of assignment to a slice (i.e., either primary or secondary slices). The information includes a storage node which manages a slice belong to the same segment (i.e., a secondary slice corresponds to a primary slice, or a primary slice corresponds to a secondary slice).

Upon the data access unit 140 accepts an access by the access node 600, the 140 manipulates data stored in the storage device 110 by referring to the slice information stored in the slice information storing unit 130.

When the data access unit 140 accepts a read request with address designated from the access node 600, the data access unit 140 judges whether the slice to which designated address belongs to is a primary slice or not. Upon the judgment revealed that it is a primary slice, the data access unit 140 acquires data corresponds to the designated address from the storage device 110, and transmits to the access node 600. Upon it was not the primary slice, the data access unit 140 notifies the access node 600 that the address designation is inappropriate.

Upon the data access unit 140 receiving a write request with address and content to write are designated, the data access unit 140 tries to write the data to the designated address in the storage device 110. The data access unit 140 notifies the result of the writing to the access node 600.

Moreover, when the slice to which the designated address belongs to is a primary slice, the data access unit 140 instructs the storage node which manages the corresponding secondary slice to write the same content to the secondary slice. The content of the primary slice and that of the secondary slice are maintained so that the contents of the two are the same. Note that when a storage node which manages the secondary slice is suspended, the data access unit 140 instructs the control node 500 to temporarily save the written content.

The slice management unit 150 periodically notifies an operation status of the storage node 100 to the control node 500. Upon the control node 500 requests for acquiring slice information, the slice management unit 150 transmits the slice information stored in the slice information storing unit 130. Upon the slice management unit 150 receiving an instruction to update slice information, the slice management unit 150 reflects the instructed update content to the slice information stored in the slice information storing unit 130.

Upon the slice management unit 150 receiving a notification to transit to power saving mode (i.e., an operation mode with either one of two groups is suspended), the slice management unit 150 changes settings of slices by manipulating slice information stored in the slice information storing unit 130 as required. Upon the slice management unit 150 receiving a notification to return to a normal mode (i.e., an operation mode in which all of storage nodes are suspended), the slice management unit 150 manipulates slice information stored in the slice information storing unit 130 as required and prepares for a transition to the normal mode.

The control node 500 has a slice information group storing unit 510, a logical volume management unit 520, a redundant data storing unit 530, and an operation mode control unit 540.

The slice information group storing unit 510 stores slice information managed by the storage nodes 100, 200, 300, and 400. The slice information stored in the unit 510 is collected from the information retained by the storage nodes 100, 200, 300, and 400.

The logical volume management unit 520 receiving notifications indicating operation statuses from the storage nodes 100, 200, 300, and 400 via the network 10. As a result the logical volume management unit 520 will find whether each storage node operates properly. The logical volume management unit 520 acquires slice information from the storage nodes 100, 200, 300, and 400 as required, and updates the slice information stored in the slice information group storing the slice information group storing unit 510. The logical volume management unit 520 creates a logical volume to be stored in the access node 600 based on the slice information of the slice information group storing unit 510.

Upon the logical volume management unit 520 creates a new segment, checks for unused slices in the storage nodes 100, 200, 300, and 400 by referring to the slice information stored in the slice information group storing unit 510. The logical volume management unit 520 assigns a primary slice and a secondary slice of a new segment to unused slices and updates the slice information and the logical volume. Note that creating a new segment is executed by receiving an instruction to create a segment by a management node 30 operated by an administrator.

The redundant data storing unit 530 temporarily stores redundant data indicating the write contents to a primary slice performed during power saving mode. The information on to which segment the writing operation is applied and a time stamp indicating the time when Write is requested is added to the redundant data.

The operation mode control unit 540 controls activation and suspension of the storage nodes 100, 200, 300, and 400. When the operation mode control unit 540 receiving an instruction to transit to a power saving mode, changes settings in order to prepare for transition to the power saving mode and turns off power of the storage nodes which belong to a group subject to suspension. Upon the operation mode control unit 540 receiving an instruction to return to the normal mode, turns on power of the storage nodes which have been suspended, and changes settings in order to return to the normal mode.

Upon the operation mode control unit 540 receiving a request for temporary storing the written content from the storage nodes 100, 200, 300, and 400 during power saving mode, the operation mode control unit 540 stores the written content as redundant data to the redundant data storing unit 530. At this operation, the operation mode control unit 540 attaches information such as a time stamp to the redundant data.

Upon the redundant data stored in the redundant data storing unit 530 exceeds a predefined amount, the operation mode control unit 540 temporarily activates storage nodes under suspension and reflects the written content indicated by the redundant data to the secondary slice. Then, the operation mode control unit 540 deletes the redundant data reflected to the secondary slice from the redundant data storing unit 530.

The access node 600 has a logical volume storing unit 610 and a data access control unit 620.

The logical volume storing unit 610 stores a logical volume. The logical volume manages each segment by logical addresses, i.e., virtual addresses in order to handle storage areas managed by the storage devices 110, 210, 310, and 410 collectively. The logical volume includes information on a logical address for identifying a segment, and information for identifying a primary slice and a secondary slice that belong to the segment. The logical volume is created and updated by the control node 500.

Upon a data access control unit 620 receiving a data access request from a program under operation, the redundant data storing unit 620 checks whether the logical volume is stored in the logical volume storing unit 610 or not. Upon the logical volume is not stored, the data access control unit 620 acquires the logical volume from a control node 500, and stores the acquired volume to the logical volume storing unit 610.

The data access control unit 620 identifies a storage node to be accessed based on the logical volume. This means that the data access control unit 620 identifies the segment to which the data to be used belongs, and identifies the storage node which manages the primary slice of the identified segment. The data access control unit 620 accesses the identified storage node.

Upon the access is failed here, status of data allocation may have been changed after acquiring a logical volume from the control node 500; the data access control unit 620 acquires latest logical volume from the control node 500 and retries access to the storage node.

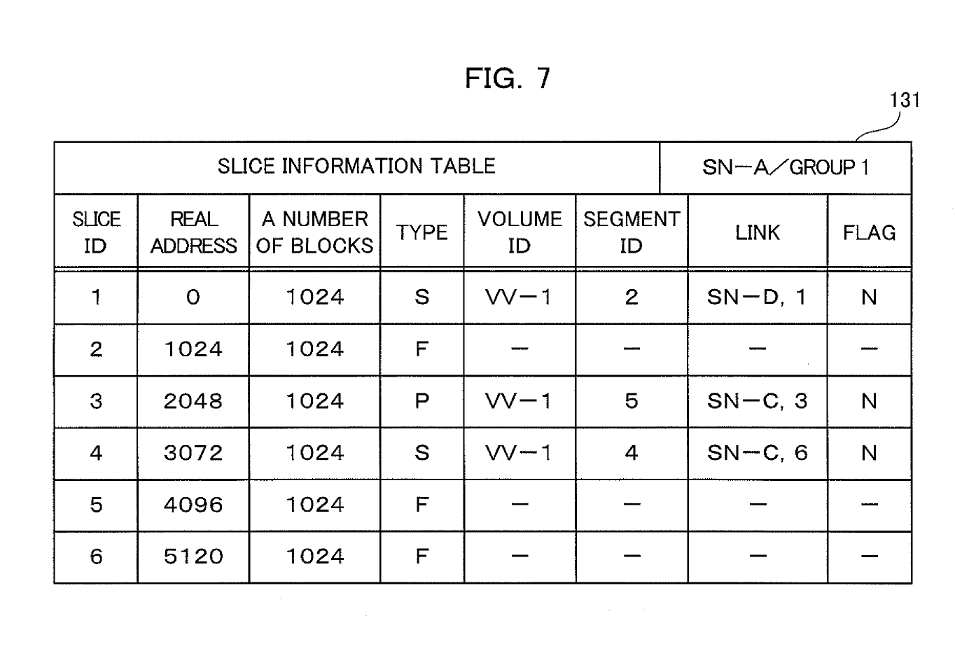

FIG. 7 illustrates a data structure of a slice information table. The slice information table 131 illustrated in FIG. 7 is stored in the slice information storing unit 130 of the storage node 100. In other words, the slice information table 131 describes information on slices managed by the storage node 100.

In the slice information table 131, a node ID of the storage node 100 that is “SN-A” and a group ID to which the storage node 100 belongs that is “Group 1” are described.

The slice information table 131 provides items indicating a slice ID, a real address, a number of blocks, a type, a volume ID, a segment ID, a link, and a flag. Information of items on the same line are linked each other and comprises information on one slice.

For the item indicating a slice ID, a slice ID is set. For the item indicating a real address, a physical address indicating a first block of a slice is set. For the item indicating a number of blocks, the number of blocks included in a slice is set. For the item indicating a type, either one of the values, “P”, “S”, or “F” is set. The “P” indicates a primary slice, while “S” indicates a secondary slice, and “F” (meaning Free) indicates no segment corresponds to. For the item indicating a volume ID, a logical volume ID of the volume to which a segment corresponds to a slice belongs to is set. For the item indicating a segment, a segment ID of a segment corresponds to a slice is set.

For the item indicating a link, when the type of a slice is “P”, the storage node ID of the storage node to which corresponding secondary slice is allocated and the slice ID are set. For the slice a type of which is “S”, the storage node ID of the storage node to which corresponding primary slice is allocated and the slice ID are set.

For the item indicating a flag, either one of “Y” or “N” is set. The “Y” indicates the roles of primary slice and secondary slice are replaced for the slice with a transition to a power saving mode. The N indicates the roles of the primary slice and the secondary slice are not replaced. At a normal mode, always “N” is set.

Slice information stored in the slice information table 131 is updated by the slice management unit 150 as appropriate. The same table is stored in the slice information group storing unit 510 of the control node 500 as well.

For instance, following information is stored: a slice ID is “1”, a real address is “0”, the number of blocks is “1024”, a type is “S”, a volume ID is “VV-1”, a segment ID is “2”, a link is “SN-D, 1”, and the flag is “N”.

This indicates that storage area from block 0 to block 1023 managed by the storage node 100 constitutes one slice, and the second segment of a logical volume “VV-1” is assigned. A primary slice corresponds to the secondary slice is assigned to the first slice of the storage node “SN-D”.

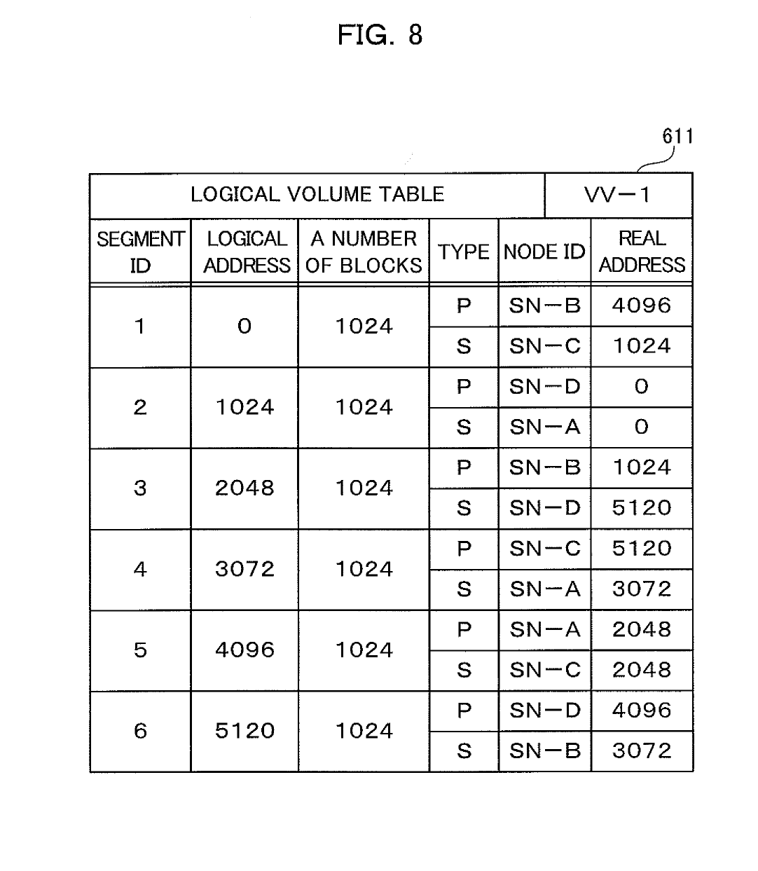

FIG. 8 illustrates a data structure of a logical volume table. A logical volume table 611 illustrated in FIG. 8 is a table describing a logical volume “VV-1”. The table 611 is stored in the logical volume storing unit 610 of the access node 600.

The logical volume table 611 provides items indicating a segment ID, a logical address, a number of blocks, a type, a node ID, and a real address. Information of items on the same line are linked each other.

For the item indicating a segment ID, a segment ID which identifies a segment is set. For the item indicating a logical address, a virtual address on a logical volume indicating a first block of the segment is set. For the item indicating a number of blocks, the number of blocks included in, the segment is set.

For the item indicating a type, either one of the values, “P” or “S” is set. For the item indicating a node, a node ID identifying a storage node to which data is assigned is set. For the item indicating a real address, a physical address indicating a first block of a slice to which data is assigned.

Information to be stored in the logical volume table 611 is created by the logical volume management unit 520 based on the slice information stored in the slice information group storing unit 510 of the control node 500.

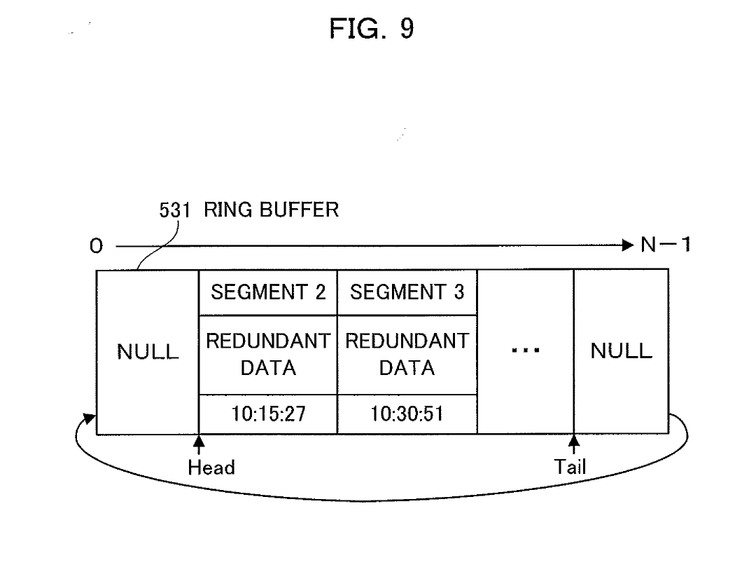

FIG. 9 illustrates an example of structure of a ring buffer where redundant data is stored. The redundant data storing unit 530 of the control node 500 stores redundant data in a ring buffer 531 and manages the data.

In the ring buffer 531, a fixed area of N size is assigned as a storage area. That is a storage area in which an address from 0 to N-1 is assigned. Upon data is stored in the ring buffer 531, data is stored from the head of the storage area (i.e., a position that the address is 0), and data is sequentially added to the end of storage area to which data has been last stored. Upon data is taken out of the ring buffer 531, data is sequentially taken out of the head of the area to which data has been stored.

In the ring buffer 531, a Head pointer indicating the head of area to which data has been stored, and a Tail pointer indicating the tail of area to which data has been stored are set. The Head pointer moves to a head of the next data whenever data is taken out. The Tail pointer moves to the tail of newly added data whenever data is added. The Tail pointer returns to the head of the storage area (i.e., the address is 0) when the position of pointer exceeds the tail of storage area (i.e., the address is N-1). Thus, the fixed area of the ring buffer 531 is reused sequentially.

The ring buffer 531 temporarily stores contents of writing performed during power saving mode as redundant data. This is because contents of writing to a primary slice cannot be reflected to the secondary slice as appropriate during power saving mode. The ring buffer 531 sequentially stores redundant data indicating the contents of writing. At this time, a segment ID identifying a segment of a logical volume and a time stamp indicating when the Write is requested is added to the redundant data.

The storage area of the ring buffer 531 is limited; therefore a maximum permissible size for redundant data is preset to the ring buffer 531. Amount of redundant data currently stored is calculated, for example, based on a distance from a Head pointer to Tail pointer. Amount of redundant data is continuously monitored by the operation mode control unit 540 of the control node 500.

Redundant data stored in the ring buffer 531 may be content of data operation, or the data itself after the update of the block subjected to be updated, or the data itself after the update of entire segment subjected to be updated.

Now, details of processing performed by the distributed system with above configuration and data structure are explained. First, processing to transit to power saving mode by the operation mode control unit 540 of the control node 500 in response to a command to transit to power saving mode will be explained.

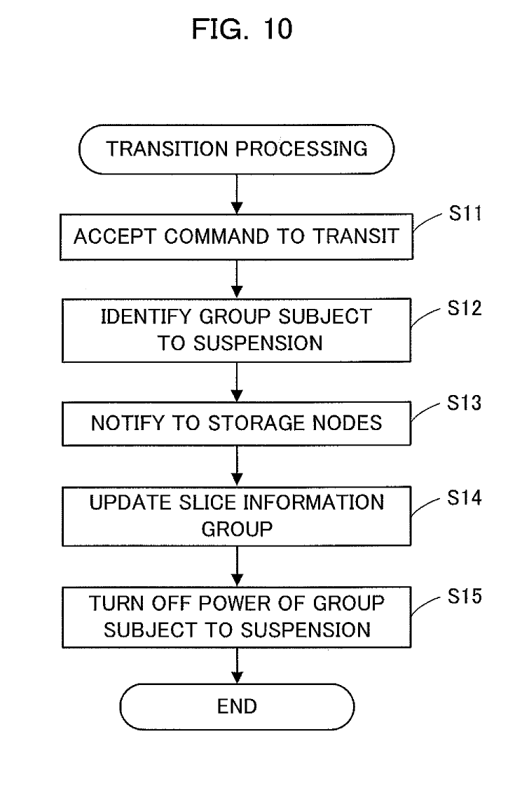

FIG. 10 illustrates processing of transition to power saving mode. Processing illustrated in FIG. 10 will be explained by referring to operation numbers.

In operation S11, the operation mode control unit 540 accepts a command to transit to power saving mode. The following three cases are considered for a command to transit to power saving mode is issued. First, an administrator operates the management node 30 and manually issues a command to transit to power saving mode. Second, time to transit to power saving mode is preset by the management node 30 or the control node 500 and the command to transit to power saving mode is automatically issued at the preset time (e.g., a time when access load of the storage nodes 100, 200, 300, and 400 are expected to be light). Third, the control node 500 or the management node 30 monitors access load of the storage nodes 100, 200, 300, and 400, and the command to transit to power saving mode is automatically issued when the access load become lower than the threshold value.

In operation S12, the operation mode control unit 540 identifies a group of storage nodes to be suspended when transits to power saving mode. One of the following four methods to identify a group to be suspended is selected and preset to the operation mode control unit 540. First method is designating a group to be suspended in each time by the control node 30. Second method is randomly selecting one of the group 1 or group 2. Third method is fixing a group to be suspended to either the group 1 or group 2. Fourth method is alternately selecting either the group 1 or group 2 by a round robin method.

In operation S13, thee operation mode control unit 540 notifies a transition to power saving mode to the storage nodes 100, 200, 300, and 400. Upon receiving the notification, at the storage nodes 100, 200, 300, and 400, slice information managed by such storage nodes are updated respectively. That is a type of a primary slice and a secondary slice is replaced as required so that the primary slice is not assigned to the storage node which belongs to a group to be suspended.

In operation S14, the operation mode control unit 540 applies similar updates as operation 13 to slice information stored in the slice information group storing unit 510. Then, the logical volume management unit 520 updates a logical volume based on the updated slice information.

In operation S15, the operation mode control unit 540 makes notifications of power-off to storage nodes that belong to the group specified at operation S12. The notified storage nodes turn off the power in response to the notification of power-off.

As mentioned above, the control node 500 identifies a group to be suspended when a command to transit to power saving mode is received. The control node 500 updates slice information and logical volume, and sets the status so that a primary slice is not assigned to a storage node subject to suspension. After that, the control node 500 turns off the power of storage nodes belong to a group subject to suspension.

As mentioned above, the control node 500 notifies a transition to power saving mode to the storage nodes 100, 200, 300, and 400 (above Operation S13). The slice information and logical volume of the control node 500 is updated (above Operation S14). However, the order of the processes can be reversed.

Specific methods to update slice information in which the control node 500 notifies the storage nodes 100, 200, 300, and 400 and make them update the slice information include following two methods (above Operation S14). One method is that the control node 500 instructs the detail of updates to the storage nodes 100, 200, 300, and 400, and the other method is that notifying transition to power saving mode to the storage nodes 100, 200, 300, and 400, and let the storage nodes 100, 200, 300, and 400 judge the content of update. The reason why these two methods can be taken is that the control node 500 and the storage nodes 100, 200, 300, and 400 both retain common slice information.

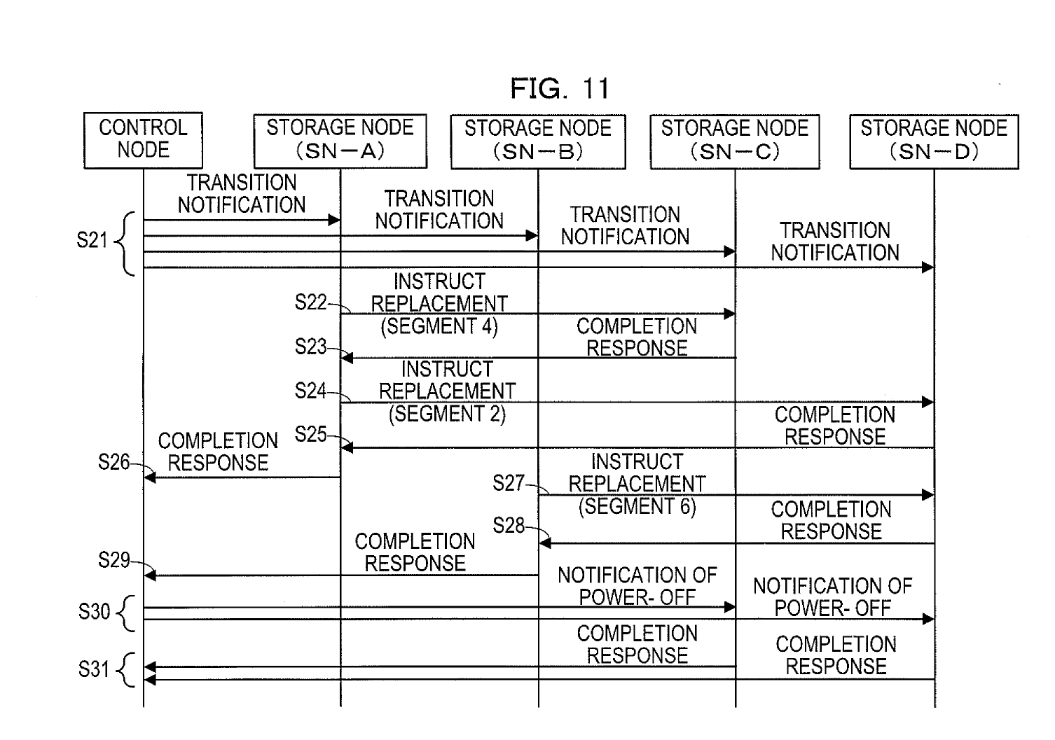

FIG. 11 illustrates an example of transition to power saving mode. It is assumed here that a group 2 to which storage nodes 300 and 400 belong to is subject to suspension.

Next, processing illustrated in FIG. 11 will be explained by referring to operation numbers.

In operation S21, the control node 500 notifies a transition to power saving mode to the storage nodes 100, 200, 300, and 400. In the notification, a group ID, “group 2” of a group to be suspended is specified.

In operation S22, the storage node 100 confirms that the node itself does not belong to a group to be suspended, i.e., the storage node 100 belongs to a group continuously operates. The storage node 100 searches for slice information to identify the segment 4 and segment 2 to which the secondary slice assigned to the storage node 100 belong to. The storage node 100 instructs the storage node 300 to which a primary slice of the segment 4 is assigned to replace the slice type.

In operation S23, the storage node 300 changes the slice type of the segment 4 from a primary slice to a secondary slice. The storage node 300 makes a completion response to the storage node 100. Upon receiving the completion response, the storage node 100 changes the slice type of the segment 4 from a secondary slice to a primary slice.

In operation S24, the storage node 100 instructs the storage node 400 to which the primary slice of the segment 2 is assigned to replace the type of slices.

in operation S25, the storage node 400 changes the slice type of the segment 2 from a primary slice to a secondary slice. The storage node 400 makes a completion response to the storage node 100. Upon receiving the completion response, the storage node 100 changes the slice type of the segment 2 from a secondary slice to a primary slice.

In operation S26, the storage node 100 makes a completion response to the control node 500 that indicates replacing type of slices managed by the storage node 100 completes.

In operation S27, the storage node 200 confirms that the node itself does not belong to a group to be suspended. The storage node 200 searches for slice information to identify the segment 6 to which the secondary slice assigned to the storage node 200 belong to. The storage node 200 instructs the storage node 400 to which a primary slice of the segment 6 is assigned to replace the slice type.

In operation S28, the storage node 400 changes the slice type of the segment 6 from a primary slice to a secondary slice. The storage node 400 makes a completion response to the storage node 200. Upon receiving the completion response, the storage node 200 changes the slice type of the segment 6 from a secondary slice to a primary slice.

In operation S29, the storage node 200 makes a completion response to the control node 500 that indicates replacing type of slices managed by the storage node 200 completes.

In operation S30, when the control node 500 confirms the completion of replacing slice type by the responses of the completions at Operation S26 and Operation S29, the control node 500 notifies the storage nodes 300 and 400 to turn off the power respectively. Note that storage nodes 300 and 400 which belong to a group to be suspended do not transmit the responses of completion.

In operation S31, the storage nodes 300 and 400 make a completion response to the control node 500 respectively immediately before the power is turned off.

Thus, slice information managed by the storage nodes 100, 200, 300, and 400 are updated, and the slice type assigned to the storage nodes 300 and 400 are all changed to the secondary slice. Then, the power of the storage nodes 300 and 400 are turned off. Note that processing of above operations S22 to S26 and operations S27 to S29 can be performed in parallel.

In the method illustrated in FIG. 11, updates of slice information is performed only by communication among storage nodes once the control node 500 notifies the transition to power saving mode to the storage nodes 100, 200, 300, and 400. Replacement of slice type can be performed by sending and receiving only the instruction information and no need to send and receive data on the slice itself. This enables to reduce processing load for the control node 500 and load of communication to the network 10.

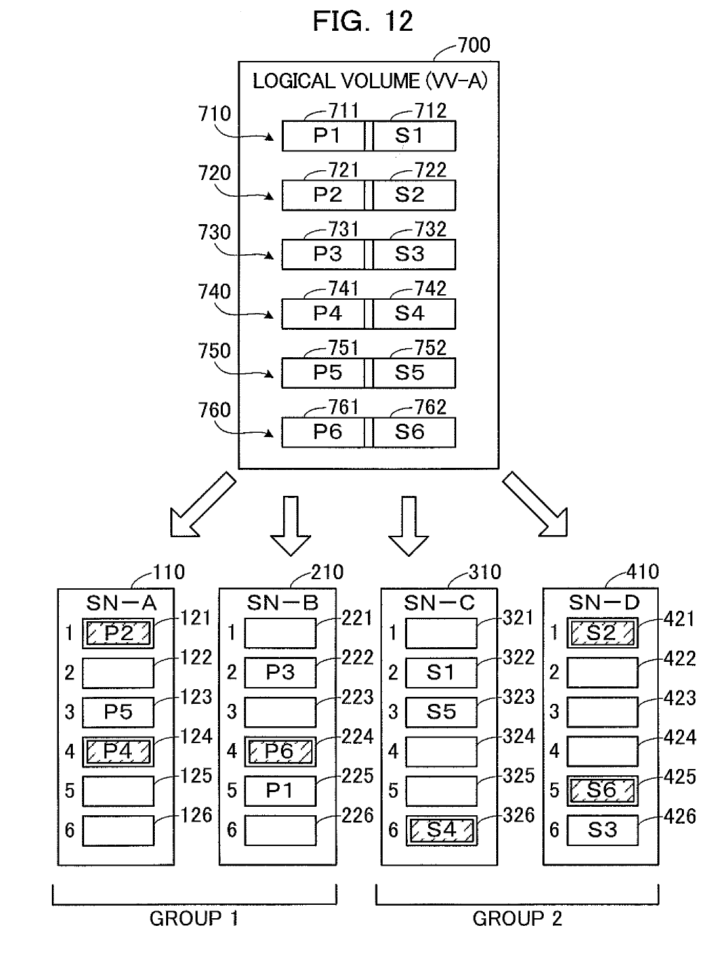

FIG. 12 illustrates a second data structure of a logical volume. As a result of the processing illustrated in FIG. 11, the assignment status illustrated in FIG. 5 is changed to the assignment condition of primary slices and secondary slices illustrated in FIG. 12.

The allocation destination of the primary slice 721 and that of the secondary slice 722 are replaced. The allocation destination of the primary slice 741 and that of the secondary slice 742 are replaced as well. Moreover, the allocation destination of the primary slice 761 and that of the secondary slice 762 are replaced. Note that the content of the primary slices 721, 7411 and 761 and that of the secondary slices 722, 742, and 762 are the same. Therefore, no data is actually moved.

As illustrated in FIG. 12, only secondary slices are assigned to the storage nodes 300 and 400 which belong to the group 2. Thus, power of the storage nodes 300 and 400 can be turned off without interrupting data accesses.

Next, a processing flow is explained wherein redundant data is stored to the control node 500 when a Write request is generated during power saving mode.

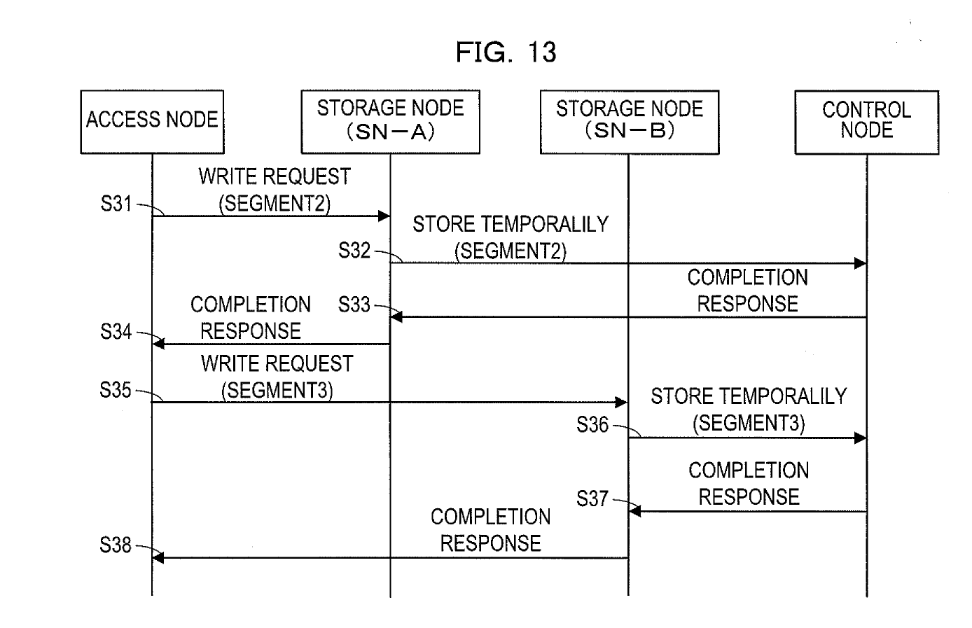

FIG. 13 illustrates an example of a flow of writing data during power saving mode.

Processing illustrated in FIG. 13 will be explained by referring to the operation numbers.

In operation S31, when the writing data is required, the access node 600 identifies a segment to which a writing destination belongs to by referring to a logical volume. Assume here that a writing destination is a segment 2. The access node 600 performs a Write request to the storage node 100 to which the primary slice of the segment 2 is assigned.

In operation S32, upon receiving the Write request, the storage node 100 performs a writing operation to the storage node 100. Since the distributed storage system is in power saving mode at the data operation, the storage node 100 requests the control node 500 to temporarily stores the write contents for the segment 2.

In operation S33, upon receiving the request for temporarily stores the data, the control node 500 stores the write contents for the segment 2 as redundant data. The control node 500 makes a completion response to the storage node 100.

In operation S34, the storage node 100 makes a completion response for the Write request to the access node 600.

In operation S35, as in the Operation S31, when writing data to a segment 3 is E required, the access node 600 makes a Write request to the storage node 200 to which a primary slice of the segment 3 is assigned.

In operation S36, upon receiving the Write request, the storage node 200 performs the writing operation to the storage node 210. Since the distributed storage system is in power saving mode at the data operation, the storage node 200 requests the control node 500 to temporarily stores the write contents to the segment 3.

In operation S37, upon receiving the request for temporarily stores the data, the control node 500 stores the write contents for the segment 3 as redundant data. The control node 500 makes a completion response to the storage node 200.

In operation S38, the storage node 200 makes a completion response for the Write request to the access node 600.

As mentioned above, when a Write request is made to the storage nodes 100 and 200 with the storage nodes 300 and 400 suspended, the write contents is notified from the storage nodes 100 and 200 to the control node 500 and stored. That is, the control node 500 stores redundant data indicating the write contents.

Next, a processing in which the control node 500 reflects content of redundant data to a secondary slice will be explained.

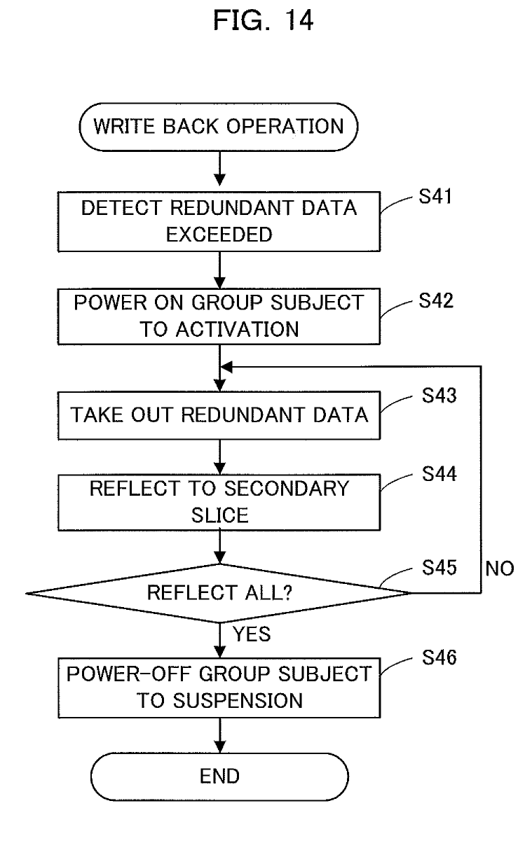

FIG. 14 illustrates a processing of a write back operation of redundant data.

A processing illustrated in FIG. 14 will be explained by referring to the operation numbers.

In operation S41, the operation mode control unit 540 continuously monitors amount of redundant data stored in the redundant data storing unit 530. Then, the operation mode control unit 540 detects that preset maximum permissible size is exceeded.

In operation S42, the operation mode control unit 540 makes a notification of power-on to storage nodes the power of which were turned off with transition to power saving mode. Thus, the states of the notified storage nodes change from suspension to operation.

In operation S43, the operation mode control unit 540 takes out one redundant data stored in the redundant data storing unit 530 from the head by referring to a Head pointer. Then, the operation mode control unit 540 moves the Head pointer to the head of next redundant data.

In operation S44, the operation mode control unit 540 identifies a segment subject to writing based on a segment ID attached to the redundant data taken out at Operation S43. The operation mode control unit 540 reflects the content of the redundant data to secondary slices which belong to the identified segment.

In operation S45, operation mode control unit 540 judges whether all redundant data stored in the redundant data storing unit 530 have been taken out and reflected to the secondary slices at Operation S43 or not. If all data have been taken out, the processing proceeds to Operation S46. If any redundant data exists that has not been taken out, the processing proceeds to Operation S43.

In operation S46, operation mode control unit 540 makes a notification of power-off to the storage nodes to which the notifications of power-on were sent at Operation S42, thereby suspends the nodes again.

Thus, the control node 500 temporarily activates suspended storage nodes even during power saving mode, and writes back the write contents to the secondary slice. This ensures redundancy of data.

As mentioned above, the control node 500 writes back data to the secondary slices when accumulated redundant data exceeds the threshold value. The write back operation may be performed when predetermined time has passed since the head of redundant data has been stored.

Specific methods that the control node 500 updates secondary slices (above Operation S44) include following two methods. One method is that the control node 500 notifies the write contents to storage nodes to which secondary slices subject to update are assigned. Other method is that the control node 500 makes a synchronization notification to storage nodes to which primary slices that correspond to the secondary slices subject to update are assigned.

Specific communication flow of the latter method will be explained.

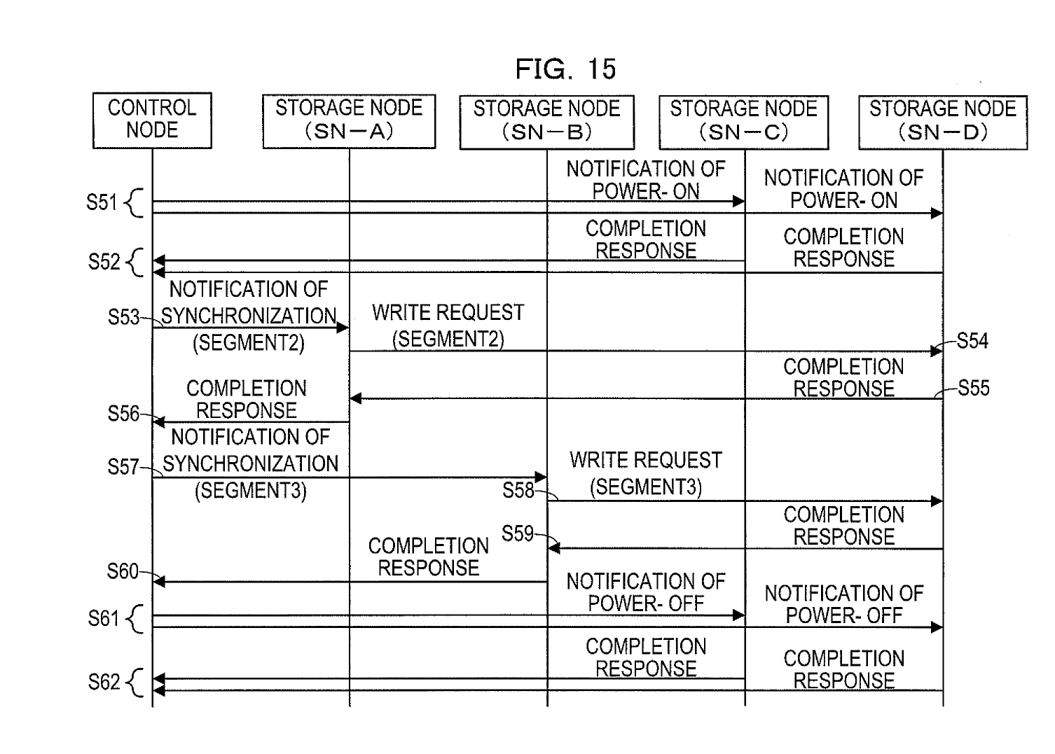

FIG. 15 illustrates a flow of a write back operation of redundant data. Assume here that storage nodes 300 and 400 which belong to the group 2 are suspended with a transition to a power saving mode.

Next, a processing illustrated in FIG. 15 will be explained by referring to the operation numbers.

In operation S51, the control node 500 makes a notification of power-on to the storage nodes 300 and 400 under suspension. Upon receiving the notification of power-on, the storage nodes 300 and 400 are activated.

In operation 552, upon the storage nodes 300 and 400 complete the activation process, the storage nodes 300 and 400 make completion responses to the control node 500 respectively.

In operation S53, the control node 500 takes out the oldest data among accumulated redundant data and identifies a segment subject to writing based on a segment ID attached to the taken out redundant data. It is assumed that the segment 2 is identified. Then, the control node 500 makes a notification of synchronization of the segment 2 to the storage node 100 to which a primary slice of segment 2 is assigned.

In operation S54, upon receiving the notification of synchronization, the storage node 100 acquires data of segment 2 from the storage device 110. Then, the storage node 100 makes a Write request to the storage node 400 to which a secondary slice of segment 2 is assigned. In operation S55, upon receiving the Write request of segment 2, the storage node 400 performs the writing operation to the storage device 410. The storage node 400 makes a completion response to the storage node 100.

In operation S56, in response to the synchronization notification, the storage node 100 makes a completion response to the control node 500.

As in Operation S53, the control node 500 takes out next redundant data and identifies a segment subject to writing. It is assumed that the segment 3 is identified. Then, the control node 500 makes a synchronization notification of the segment 3 to the storage node 200 to which a primary slice of segment 3 is assigned.

In operation S58, upon receiving the synchronization notification, the storage node 200 acquires data of segment 3 from the storage device 210. Then, the storage node 200 makes a Write request to the storage node 400 to which a secondary slice of the segment 3 is assigned.

In operation S59, upon receiving the Write request of segment 3, the storage node 400 performs the writing operation to the storage node 410. The storage node 400 makes a completion response to the storage node 200.

In operation S60, in response to the synchronization notification, the storage node 200 makes a completion response to the control node 500.

In operation S61, upon the control node 500 confirms that all redundant data have been taken out, the control node 500 makes a notification of power-off to the storage nodes 300 and 400 respectively.

In operation S62, the storage nodes 300 and 400 make completion responses to the control node 500 respectively immediately before each of powers are turned off.

As mentioned above, the control node 500 temporarily activates storage nodes which were suspended with a transition to power saving mode. Then, the control node 500 instructs the storage nodes for which primary slices of segments to which writings were performed to synchronize data. Thus data in the storage nodes 100, 200, 300, and 400 are synchronized, and contents of primary and secondary slices become the same.

A processing that an operation mode control unit 540 of a control mode 500 transit from a power saving mode to a normal mode upon receiving a command to return from power saving mode will be explained.

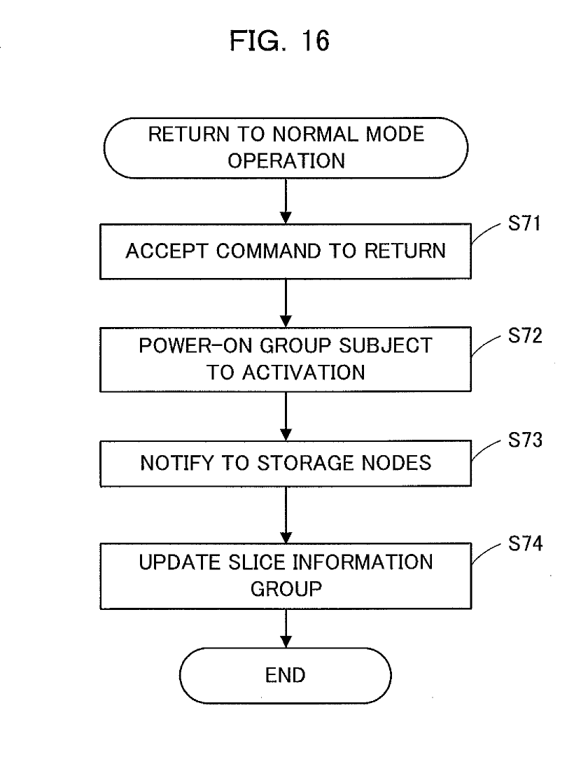

FIG. 16 illustrates a processing to return from a power saving mode. Next, a processing illustrated in FIG. 16 will be explained by referring to the operation numbers.

In operation S71, the operation mode control unit 540 receiving a command to return from power saving mode. The following three cases are considered for a command to return to a normal mode is issued. First, an administrator operates the management node 30 and manually issues a command to return to a normal mode. Second, time to transit to the normal mode is preset by the management node 30 or the control node 500 and the command to transit to the normal mode is automatically issued at the preset time (e.g., a time when access load of the storage nodes 100, 200, 300, and 400 are expected to be heavy). Thirdly, the control node 500 or the management node 30 monitors access load of the storage nodes 100, 200, 300, and 400, and the command to transit to power saving mode is issued automatically when the access load reaches or exceeds the threshold value.

In operation S72, the operation mode control unit 540 identifies a group subject to suspension with a transition to a power saving mode. The operation mode control unit 540 makes a notification of power-on to storage nodes which belong to the identified group. Thus, the notified storage nodes are activated.

In operation S73, the operation mode control unit 540 notifies a return from power saving mode to the storage nodes 100, 200, 300, and 400. Upon receiving the notification, the storage nodes 100, 200, 300, and 400 update slice information managed by each of nodes respectively. This means a type of a primary slice and that of secondary slice is returned to the original state as required and primary slices are assigned and distributed to the storage nodes 100, 200, 300, and 400. Note that whether the type of slice is changed or not can be judged based on a flag of the slice information.

In operation S74, the operation mode control unit 540 applies similar updates as Operation 73 to slice information stored in the slice information group storing unit 510. Then, the logical volume management unit 520 updates a logical volume based on the updated slice information.

As mentioned above, the control node 500 temporarily activates storage nodes which belong to a group subject to suspension, upon receiving a command to return from a power saving mode. Then, the control node 500 updates slice information and logical volume and restore the state of data allocation before transiting to power saving mode.

As mentioned above, the control node 500 makes a notification of return to a normal mode to the storage nodes 100, 200, 300, and 400 (above Operation S73). The slice information and logical volume of the control node 500 are updated (above Operation S74). However, the order of the processes may be reversed. Specific methods to update slice information in which the control node 500 notifies the storage nodes 100, 200, 300, and 400 and make them update the slice information include following two methods (above Operation S73). One method is that the control node 500 instructs the detail of updates to the storage nodes 100, 200, 300, and 400, and the other method is that notifying return to a normal mode to the storage nodes 100, 200, 300, and 400, and let the storage nodes 100, 200, 300, and 400 judge the content of update.

Specific communication flow of the latter method will be explained.

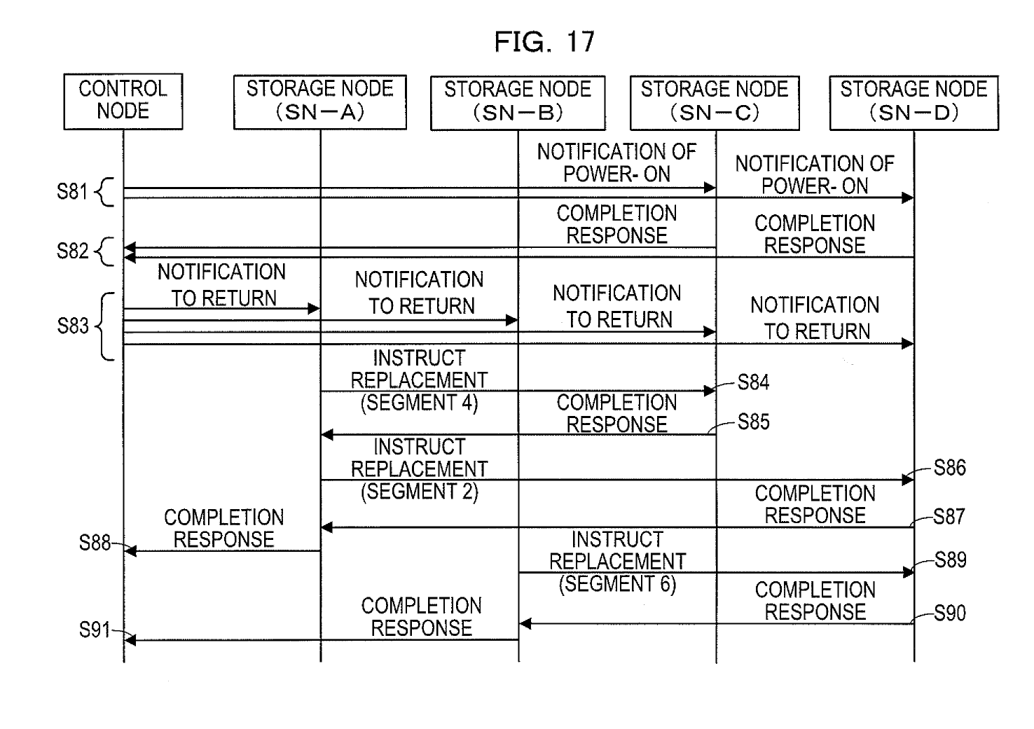

FIG. 17 illustrates an example of flow returning from a power saving mode. Assume here that a group 2 is subject to power-off during a power off mode.

Next, processing illustrated in FIG. 17 will be explained by referring to operation numbers.

In operation S81, the control node 500 makes notifications of power-on to the storage nodes 300 and 400 respectively which have been suspended during power saving mode.

In operation S82, when the storage nodes 300 and 400 complete the activation process, the storage nodes 300 and 400 make completion responses to the control node 500 respectively.

In operation S83, the control node 500 notifies a return from power saving mode to the storage nodes 100, 200, 300, and 400.

In operation S84, the storage node 100 confirms that the node itself does not belong to a group subject to suspension (i.e., the node 100 have continuously operated during power saving mode). The storage node 100 searches for slice information to identify the segment 4 and segment 2 the slice type of which are replaced with a transition to power saving mode. The storage node 100 instructs the storage node 300 to which a secondary slice of the segment 4 is assigned to replace the slice type.

In operation S85, the storage node 300 changes the slice type of the segment 4 from a secondary slice to a primary slice. The storage node 300 makes a completion response to the storage node 100. Upon receiving the completion response, the storage node 100 changes the slice type of the segment 4 from a primary slice to a secondary slice.

In operation S86, the storage node 100 instructs the storage node 400 to which the secondary slice of the segment 2 is assigned to replace the type of slices.

In operation S87, the storage node 400 changes the slice type of the segment 2 from a secondary slice to a primary slice. The storage node 400 makes a completion response to the storage node 100. Upon receiving the completion response, the storage node 100 changes the slice type of the segment 2 from a primary slice to a secondary slice.

In operation S88, the storage node 100 makes a completion response to the control node 500 that indicates replacing type of slices managed by the storage node 100 completes.

In operation S89, the storage node 200 confirms that the node itself does not belong to a group subject to suspension. The storage node 200 searches for slice information to identify the segment 6 in which the slice type is replaced with a transition to a power saving mode. The storage node 200 instructs the storage node 400 to which a secondary slice of the segment 6 is assigned to replace the slice type.

In operation S90, the storage node 400 changes the slice type of the segment 6 from a secondary slice to a primary slice. The storage node 400 makes a completion response to the storage node 200. Upon receiving the completion response, the storage node 200 changes the slice type of the segment 6 from a primary slice to a secondary slice.

In operation S91,the storage node 200 makes a completion response to the control node 500 that indicates replacing type of slices managed by the storage node 200 completes. By the completion response, the control node 500 detects that returning to a normal mode completes. Note that no response is received from the storage nodes 300 and 400 which belong to a group subject to suspension.

Thus, slice information managed by the storage nodes 100, 200, 300, and 400 are updated, and the slice type replaced with a transition to power saving mode are all returned to the original states. Note that processing of above operations S84 to S88 and operations S89 to S91 can be performed in parallel.

In the method illustrated in FIG. 17, updates of slice information is performed only by communication among storage nodes once the control node 500 notifies the transition to return to a normal mode to the storage nodes 100, 200, 300, and 400. Replacement of slice type can be performed by sending and receiving only the instruction information and no need to send and receive data on the slice itself. This enables to reduce processing load for the control node 500 and communication load for the network 10.

Using above distributed storage system enables to transit to power saving mode which is operated by a half of storage nodes during the time when access load of the storage nodes 100, 200, 300, and 400 are light. On the other hand, the system enables to return to a normal mode which is operated by all nodes during the time when access load of the storage nodes 100, 200, 300, and 400 are heavy. Thus, either a power saving mode which saves power and a normal mode which may allow maximum use of hardware resources can be switched as required. The modes can be switched only by updating slice information and logical volume, and no data needs to be moved, therefore faster switching is realized.

Upon data being written during power saving mode, above distributed storage system temporarily stores the write contents to a device other than storage nodes under suspension. The write contents are reflected to a secondary slice at a predetermined timing. Thus, even if operation in power saving mode lasts long hours, data redundancy has been maintained and prevents deterioration of reliability of the storage system. The effect of power saving can be maintained even if a lot of data is written, as a synchronization process does not take place every time data is written.

According to an example embodiment, the storage nodes 100, 200, 300, and 400 may be divided into two groups. However when there exists more nodes, the nodes may be divided into more than or equal to three groups. Moreover, according to an example embodiment, redundant data is stored in the control node 500; other device accessible from storage nodes 100, 200, 300 and 400 may be used for storing redundant data.

Furthermore, according to an example embodiment; the control node 500 centrally controls the storage nodes 100, 200, 300, and 400. However, other device such as the control node 30 operated by an administrator may make various notifications directly to the storage nodes 100, 200, 300, and 400 without going through the control node 500. The control node 500 may reflect the result of slice update to a logical volume by acquiring the slice update information from the storage nodes 100, 200, 300, and 400. Conversely, the control node 500 may further centrally control data allocation status without assigning slice information to the storage nodes 100, 200, 300, and 400.

Above explained processing functions may be realized by a computer. In this case, programs describing processing of functions that the control node 30, storage nodes 100, 200, 300, and 400 may be provided. The computer executes the programs; thereby above processing functions are realized.

To market the program, portable recording media such as DVDs and CD-ROMs on which the program is recorded may be sold. Alternatively, such program may be stored in a server computer and transferred from the server to other computers over a network.

A computer executing, for example, the above program may store in its storage device the program recorded on a portable recording medium, or transferred from the server computer to its' own storage device. The computer may read the programs from own storage device and executes processing accordingly. Alternatively, the computer can read the program directly from a portable recording medium, or the computer can execute processing according to the program every time such program is transferred from the server computer.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing embodiments may be recorded on computer-readable media comprising computer-readable recording media. The program/software implementing embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of embodiments, any combinations of the described features, functions and/or operations can be provided.

The many features and advantages of embodiments are apparent from the detailed specification and, thus, it is intended by the appended claims to cover all such features and advantages of embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof. The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing embodiments may be recorded on computer-readable media comprising computer-readable recording media. The program/software implementing embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of embodiments, any combinations of the described features, functions and/or operations can be provided.

The many features and advantages of embodiments are apparent from the detailed specification and, thus, it is intended by the appended claims to cover all such features and advantages of embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, failing within the scope thereof.

What is claimed is:

1. A recording medium which records a storage management program causing a computer managing a distributed storage system which allocates and distributes a plurality of data with the same content to a plurality of storage nodes to perform following functions, wherein;
a management information storing unit designates a primary data which may be used as a destination of access at access request and a secondary data which may be used as a backup from the plurality of data, and stores management information which defines storage nodes to allocate the primary data and the secondary data;
a data allocation unit divides the plurality of storage nodes into at least two groups, manipulates the management information stored in the management information storing unit, and assigns data allocation destination so that the data allocation destination of the primary data and the data allocation destination of the secondary data having the same content as the primary data are not in the same group;
upon receiving a command to switch to a power saving mode in which one of groups defined in the data allocation unit is suspended, an operation mode switching unit manipulates the management information stored in the management information storing unit and replaces roles of the primary data assigned to a storage node subject to suspension and the secondary data which has the same content as the primary data.

2. The recording medium which records a storage management program of claim 1 further causes the computer to function as the following;
after switching to the power saving mode, when a write request is generated for the primary data having the same content as the secondary data assigned to a storage node that belong to the group subject to suspension, a redundancy management unit causes a data storage unit to store the write contents.

3. The recording medium which records a storage management program of claim 2 further causes a computer to function as the following;
the redundancy management unit temporarily operates storage nodes which belong to a group subject to suspension and reflects write contents to the secondary data when amount of write contents stored in the predetermined data storing unit exceeds a predetermined threshold value.

4. The recording medium which records a storage management program of claim 1 further causes a computer to function as the following;
the operation mode switching unit manipulates the management information stored in the management information storing unit and returns roles of the primary data and the secondary data which were replaced with a transition to the power saving mode to the original states.

5. The recording medium which records a storage management program of claim 1 further causes a computer to function as the following;
in the management information, an address space of a logical volume used to identify data may be divided into a plurality of logical segments, and the plurality of data with the same content are managed in a unit of the logical segment; and
the operation mode switching unit replaces the roles of the primary data and the secondary data in a unit of the logical segment.

6. A storage management apparatus comprising:
a management information storing unit that designates primary data which may be used as a destination of access at access request and secondary data which may be used as a backup, and stores management information which defines storage nodes to allocate the primary data and the secondary data;
a data allocation unit that divides the plurality of storage nodes into at least two groups, manipulates the management information stored in the management information storing unit, and assigns data allocation destination so that the data allocation destination of the primary data and the data allocation destination of the secondary data having the same content as the primary data are not in the same group; and
an operation mode switching unit that manipulates the management information stored in the management information storing unit and replaces roles of the primary data assigned to a storage node belongs to the group subject to suspension and the secondary data which has the same content as the primary data, upon receiving a command to switch to a power saving mode in which one of groups defined in the data allocation unit is suspended.

7. The storage management apparatus of claim 6 further comprising:
a redundancy management unit that causes a predetermined data storage unit to store write contents after switching to the power saving mode, when a write request is generated for the primary data having the same content as the secondary data assigned to a storage node that belong to the group subject to suspension.

8. The storage management apparatus of claim 7 further comprising:
the redundancy management unit temporarily operates storage nodes which belong to a group subject to suspension and reflects write contents to the secondary data when amount of the write contents stored in the data storing unit exceeds a predetermined threshold value.

9. The storage management unit of claim 6 further comprising:
the operation mode switching unit manipulates the management information stored in the management information storing unit and returns roles of the primary data and the secondary data which were replaced with a transition to the power saving mode to the original states.

10. The storage management unit of claim 6 further comprising:
in the management information, an address space of a logical volume used to identify data may be divided into a plurality of logical segments, and the plurality of data with the same content are managed in a unit of the logical segment; and
the operation mode switching unit replaces the roles of the primary data and the secondary data in a unit of the logical segment.

11. A storage management method managing a distributed storage system in which a computer allocates and distributes a plurality of data with the same content to a plurality of storage nodes connected by a network, comprising
dividing the plurality of storage nodes into at least two groups,
designating primary data which may be used as a destination of access at access request and secondary data which may be used as a backup from the plurality of data with the same content, manipulating the management information stored in the management information storing unit, and assigning data allocation destination so that the data allocation destination of the primary data and the data allocation destination of the secondary data having the same content as the primary data are not in the same group; and
upon receiving a command to switch to a power saving mode in which one of the defined groups is suspended, manipulating the management information stored in the management information storing unit and replacing roles of the primary data assigned to a storage node belongs to the group subject to suspension and the secondary data which has the same content as the primary data.

12. The method of claim 11 further comprising:
after switching to the power saving mode, when a write request is generated for the primary data having the same content as the secondary data assigned to a storage node that belongs to the group subject to suspension, a redundancy management unit causes a data storage unit to store the write contents.

13. The method of claim 12 further comprising:
when amount of write contents stored in the predetermined data storing unit exceeds a predetermined threshold value, temporarily operates storage nodes which belong to a group subject to suspension and reflects the write contents to the secondary data.

14. The method of claim 11 further comprising:
after switching to the power saving mode, the operation mode switching unit manipulates the management information stored in the management information storing unit and returns roles of the primary data and the secondary data which were replaced with a transition to the power saving mode to the original states.

15. The method of claim 11 further comprising:
in the management information, dividing an address space of a logical volume used to identify data into a plurality of logical segments, and managing a plurality of data with the same content in a unit of the logical segment; and
replacing the roles of the primary data and the secondary data in a unit of the logical segment.
